(19) United States
(12) Patent Application Publication
(10) Pub. No.: US 2025/0248872 A1
(43) Pub. Date: Aug. 7, 2025

(54) MEDICAL BED MATTRESS, MEDICAL IMAGE EXAMINATION APPARATUS, MEDICAL IMAGE EXAMINATION METHOD, AND MEDICAL IMAGE EXAMINATION PROGRAM

(71) Applicant: FUJIFILM Corporation, Tokyo (JP)

(72) Inventors: Yuta INOUE, Tokyo (JP); Hiroki SADAMARU, Tokyo (JP)

(73) Assignee: FUJIFILM Corporation, Tokyo (JP)

(21) Appl. No.: 19/035,733

(22) Filed: Jan. 23, 2025

(30) Foreign Application Priority Data
Feb. 6, 2024 (JP) 2024-016513

(51) Int. Cl. A61G 7/05; A61G 7/07

(52) U.S. Cl. CPC A61G 7/0503; A61G 7/0506; A61G 7/072

(57) ABSTRACT

A medical bed mattress includes an optically transparent or translucent portion in at least a part of at least one holding unit of the pair of holding units. In addition, the marking is provided on the holding part. By checking the marking, it is possible to check the holding state by the holding part.

### CROSS-REFERENCE TO RELATED APPLICATIONS

This application claims priority under 35 USC 119 from Japanese Patent Application No. 2024-016513 filed on Feb. 6, 2024, the disclosure of which is incorporated by reference herein.

### BACKGROUND

### 1. Technical Field

The present disclosure relates to a medical bed mattress, a medical image examination apparatus, a medical image examination method, and a medical image examination program.

### 2. Related Art

JP4013559B proposes a medical bed mattress comprising an auxiliary member in which a top plate mattress which is disposed on a top plate of a medical bed and on which a subject is placed is expandable according to a physique of the subject, and the auxiliary member is formed of a sheet-like material that is deformable in a curved shape.

JP2023-72051A proposes a fixation belt that restrains a subject in a certain posture by spreading from left and right side surfaces of a top plate that is movable in a body axis direction with the subject placed thereon to an upper surface side, and a shape in plan view of an edge portion thereof is a smooth slope with respect to a movement direction of the top plate.

JP2022-527610A proposes a bed apparatus comprising a top plate on which a subject is placed, at least a pair of holding unit provided to face the vicinities of both ends of the top plate in a width direction and to abut both side surfaces of the subject, a pressure control unit that controls a pressure of the holding unit abutting the subject, and a movement unit that moves the top plate and the holding unit.

### SUMMARY

In a medical image examination apparatus such as CT or MRI having a bed, a fixing unit is provided on a top plate or a bed mattress placed on the bed in order to position and fix the top plate and a subject with respect to the medical image examination apparatus or to ensure the safety of the subject. For example, the safety may be ensured by providing holding parts at both ends of the bed mattress and holding each arm with the holding parts.

However, since the subject is wrapped with the holding part at the arm, it is difficult to check the state of the subject, and it may be difficult to check whether the subject is appropriately held and fixed. In particular, in a case of an unskilled technician, it may take time.

The present disclosure has been made in consideration of the above-described circumstances, and an object of the present disclosure is to provide a medical bed mattress, a medical image examination apparatus, a medical image examination method, and a medical image examination program capable of checking whether a subject is appropriately fixed.

In order to achieve the above object, a medical bed mattress according to a first aspect of the present disclosure comprises: a pair of holding parts that are disposed to be in contact with both side surfaces of a subject; and a mark that is provided on at least one holding part of the pair of holding parts and that is used to check a positional relationship between the holding part and the subject.

A medical bed mattress according to a second aspect of the present disclosure is the medical bed mattress according to the first aspect, in which the holding part has a translucent or transparent portion in at least a part of the holding part.

A medical image examination apparatus according to a third aspect of the present disclosure comprises: a processor, and the processor is configured to perform processing of: detecting the mark provided on the medical bed mattress according to the first aspect; and notifying of a detection result of the mark.

A medical image examination apparatus according to a fourth aspect of the present disclosure is the medical image examination apparatus according to the third aspect, in which the processor is configured to determine whether a detected state of the mark is a predetermined state and notify of a determination result as the detection result of the mark.

A medical image examination apparatus according to a fifth aspect of the present disclosure is the medical image examination apparatus according to the fourth aspect, in which the processor is configured to: detect the mark and the subject using a captured image captured by an imaging unit that images the mark and the subject; and determine whether the detected state of the mark is the predetermined state by determining whether a positional relationship between the mark and the subject is within a predetermined range.

A medical image examination apparatus according to a sixth aspect of the present disclosure is the medical image examination apparatus according to the fourth aspect, in which the processor is configured to notify that a holding state of the holding part is defective in a case where the holding part is not in a predetermined state.

A medical image examination apparatus according to a seventh aspect of the present disclosure is the medical image examination apparatus according to the fourth aspect, in which the processor is configured to notify that a holding state of the holding part is favorable in a case where the holding part is in a predetermined state.

A medical image examination apparatus according to an eighth aspect of the present disclosure is the medical image examination apparatus according to the sixth aspect, in which a plurality of the marks are provided on the medical bed mattress, and the processor is configured to notify of a location at which the holding state of the holding part is defective.

A medical image examination apparatus according to a ninth aspect of the present disclosure is the medical image examination apparatus according to the eighth aspect, in which the processor is configured to: detect the plurality of marks; and notify of a position of the mark detected as defective, as the location at which the holding state of the holding part is defective.

A medical image examination method according to a tenth aspect of the present disclosure comprises, via a computer, performing processing of: detecting the mark provided on the medical bed mattress according to the first aspect; and notifying of a detection result of the mark.

A medical image examination program according to an eleventh aspect of the present disclosure causes a computer to execute processing of: detecting the mark provided on the medical bed mattress according to the first aspect; and notifying of a detection result of the mark.

According to the present disclosure, it is possible to provide a medical bed mattress, a medical image examination apparatus, a medical image examination method, and a medical image examination program capable of checking whether a subject is appropriately fixed.

### BRIEF DESCRIPTION OF THE DRAWINGS

Exemplary embodiments of the technology of the disclosure will be described in detail based on the following figures, wherein:

FIG. 1 is a diagram showing a medical bed mattress according to the present embodiment;

FIG. 2 is a diagram showing an example of a marking provided on a holding part of the medical bed mattress according to the present embodiment;

FIG. 3 is a block diagram showing a schematic configuration of a medical image examination system according to the present embodiment;

FIG. 4 is a block diagram showing an example of a configuration of main parts of a medical image examination apparatus and a console;

FIG. 5 is a diagram for describing an example of a method of determining whether a medical bed mattress is set such that a subject is appropriately held in a case where an optical imaging device or a sensor is applied as a detection unit;

FIG. 6 is a diagram for describing an example of a method of determining whether a medical bed mattress is set so as to appropriately hold a subject in a case where an optical imaging unit is applied as a detection unit; and

FIG. 7 is a flowchart showing an example of a flow of processing performed by a controller of the medical image examination apparatus or the console of the medical image examination system according to the present embodiment.

### DETAILED DESCRIPTION

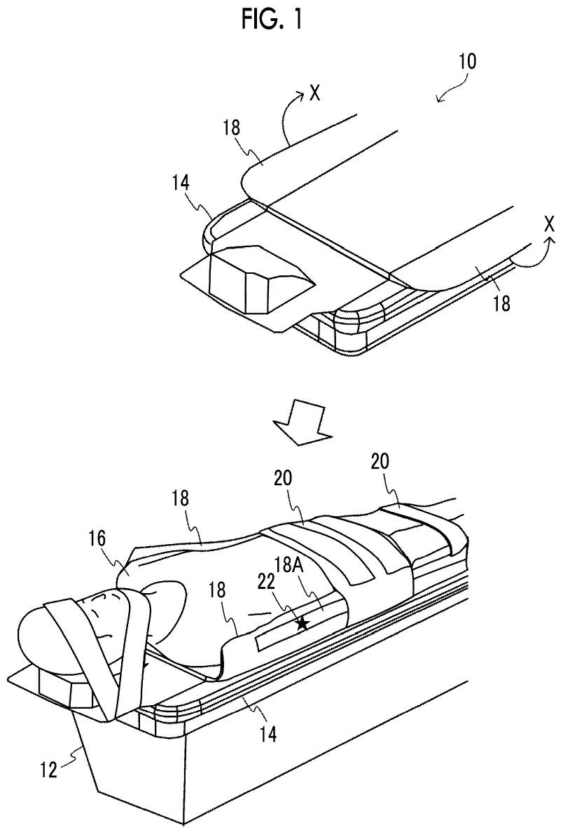

Hereinafter, an embodiment of the present invention will be described in detail with reference to the drawings. The present embodiment does not limit the present invention. FIG. 1 is a diagram showing a medical bed mattress according to the present embodiment.

The medical bed mattress 10 according to the present embodiment is provided on a bed of a medical image examination apparatus such as computed tomography (CT), magnetic resonance imaging (MRI), an X-ray examination apparatus, or positron emission tomography (PET).

The medical bed mattress 10 is placed on a bed 12 of a medical image examination apparatus, and comprises a holding part (holder) 18 for positioning and fixing the top plate 14 of the bed 12 of the medical image examination apparatus and the subject 16 with respect to the medical image examination apparatus or for ensuring safety of the subject 16. The holding part 18 is provided in a pair so as to be in contact with both side surfaces of the subject 16, and the subject 16 can be held by moving the holding part 18 in a direction of the arrow X in FIG. 1 and fixing the holding part 18 with the fixing belt 20 or the like with respect to the subject 16 placed on the medical bed mattress 10. The holding part 18 may have a mesh shape in consideration of the skin feeling. In addition, as the holding part 18, a member that absorbs sweat (for example, cotton, hemp, a combination of cotton and hemp, or the like) may be applied, or a member that has quick drying properties without absorbing sweat (for example, polyester or the like) may be applied in order to prevent dirt. In addition, the color of the holding part is preferably a color that is easily distinguished from the subject 16 (for example, black or blue).

By the way, the holding part 18 is a sheet-like member, and as shown in FIG. 1, the subject may be fixed by holding the subject 16 with the holding part 18 with each arm of the subject. In a case where each arm of the subject 16 is wrapped by the holding part 18, it is difficult to check the state of the subject 16, and it may be difficult to check whether the subject is appropriately held and fixed.

Therefore, the medical bed mattress 10 according to the present embodiment includes an optically transparent or translucent portion 18A in at least a part of at least one holding unit 18 of the pair of holding units 18. The transparent or translucent portion 18A of the holding part 18 may be colored. For example, the transparent or translucent portion 18A may be colored in a color that is easily recognized by a camera (light color such as light blue or yellow).

The term “optically transparent or translucent” means that the transparent or translucent portion 18A is transparent or translucent to an extent that the body of the subject 16 held by the holding part 18 of the medical bed mattress 10 or the holding state of the body can be visually recognized by an operator such as a technician. For example, the total light transmittance measured in accordance with “ISO 13468-1” may be 50% or more. In addition, the total light transmittance is more preferably 70% or more and still more preferably 85% or more. As the total light transmittance is increased, the visibility of the body of the subject 16 can be improved. It should be noted that the method of measuring the total light transmittance is not limited to ISO 13468-1 (corresponding to JIS K 7361-1), and for example, other measurement methods, such as JIS K 7375, can also be used.

In addition, in the present embodiment, the marking 22 as an example of the mark is provided on the holding part 18. By checking the marking 22, it is possible to check the holding state by the holding part 18. The marking 22 may be provided on the transparent or translucent portion 18A of the holding part 18, or the transparent or translucent portion 18A and the marking 22 may be provided at different positions. In addition, the marking 22 may be used as a reference for registration such as a scan imaging.

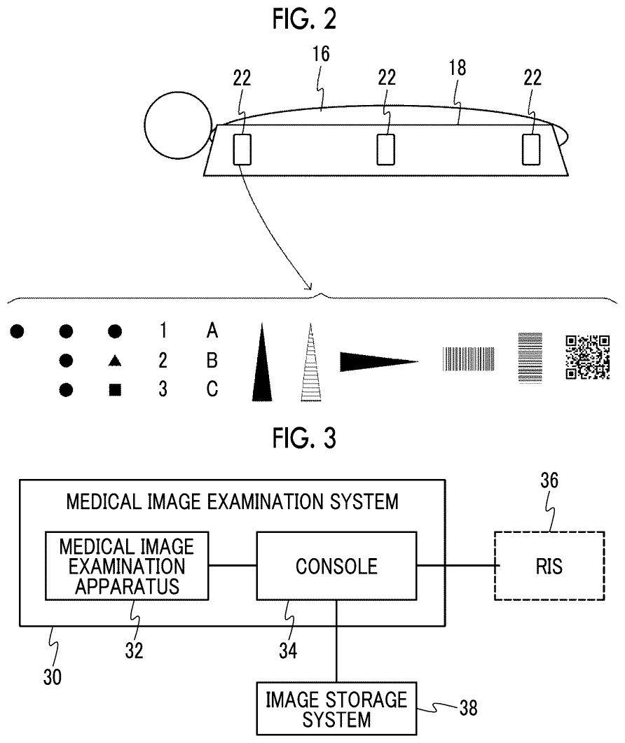

FIG. 2 is a diagram showing an example of a marking 22 provided in the holding part 18 of the medical bed mattress 10 according to the present embodiment.

For example, as shown in FIG. 2, the marking 22 is provided at a plurality of positions of the holding part 18, and various shapes are applied. For example, a figure having a shape such as a circle, a triangle, or a square may be applied to the marking 22, or a plurality of figures having a shape such as a circle, a triangle, or a square may be applied. Alternatively, the marking 22 may be a number or a character. Alternatively, the marking 22 may be a rectangular figure in which the body axis direction of the subject 16 (the left-right direction of FIG. 2) is a short side, or may be a triangular figure that is long in a direction orthogonal to the body axis direction of the subject 16 (the up-down direction of FIG. 2) or in the body axis direction of the subject 16 (the left-right direction of FIG. 2). The figure may be filled with a predetermined color or may be hatched. In addition, the marking 22 may be a one-dimensional barcode or a two-dimensional barcode.

The position of the marking 22 may be changeable with respect to the holding part 18. For example, the marking 22 may be movable on a zipper-like rail, or may be attachable and detachable by a magic tape (registered trademark), a button, or the like.

Next, a medical image examination system according to the present embodiment will be described. FIG. 3 is a block diagram showing a schematic configuration of a medical image examination system according to the present embodiment.

As shown in FIG. 3, the medical image examination system 30 according to the present embodiment comprises a medical image examination apparatus 32 and a console 34.

As the medical image examination apparatus 32, various medical image examination apparatuses are applied, and an image inside the body of the subject 16 is captured. For example, CT, MRI, an X-ray detection apparatus, PET, or the like is applied. For example, in a case of CT or X-ray detection apparatus, a radiation image is acquired by irradiating the subject 16 with radiation, and in a case of MRI, a magnetic resonance image is acquired from the subject 16 using a magnet and electromagnetic waves.

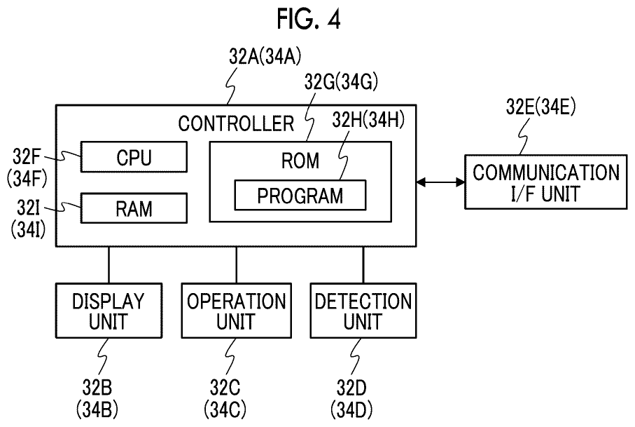

The console 34 has a function of controlling the medical image examination apparatus 32 using an imaging order and various types of information acquired from a radiology information system (RIS) 36 or the like via a wireless communication local area network (LAN) or the like, and an instruction or the like given by a user using an operation unit 32C (see FIG. 4) or the like. In addition, the console 34 is connected to the image storage system 38 by wireless communication or wired communication, and has a function of transmitting and storing various images obtained by the medical image examination apparatus 32 in the image storage system 38, such as picture archiving and communication systems (PACS).

FIG. 4 is a block diagram showing an example of a configuration of main parts of the medical image examination apparatus 32 and the console 34. Since the main parts of the medical image examination apparatus 32 and the console 34 have a general computer configuration, the medical image examination apparatus 32 will be described as a representative.

As shown in FIG. 4, the medical image examination apparatus 32 comprises a controller 32A, a display unit 32B, an operation unit 32C, a detection unit 32D, and a communication interface (I/F) unit 32E.

The controller 32A controls the overall operation of the medical image examination apparatus 32. The controller 32A comprises a CPU 32F, a ROM 32G, and a RAM 32I. The ROM 32G stores in advance various programs 32H and the like executed by the CPU 32F, such as an imaging processing program and a display processing program executed in a case of controlling imaging. The RAM 32I temporarily stores various types of data.

The display unit 32B displays a screen for operating the medical image examination apparatus 32, a detection result of the detection unit 32D, a captured radiation image, a captured magnetic resonance image, and the like. For example, a direct-viewing electronic display is applied as the display unit 32B.

The operation unit 32C is used by the user to input an instruction or various types of information related to imaging. Note that, operation unit 32C is not particularly limited, and examples of the operation unit 32C include various switches, a touch panel, a touch pen, a mouse, and the like.

The detection unit 32D detects the marking 22 provided in the holding part 18 of the medical bed mattress 10. For example, an optical imaging device such as a camera or an infrared camera, a photo sensor such as a reflective type photo interrupter, or a barcode sensor is applied as the detection unit 32D. For example, a plurality of the detection units 32D may be provided on a ceiling of the examination room, a wall surface, a housing of the medical image examination apparatus 32, and the like. In addition, the detection unit 32D may be installed on a mobile carriage, a portable tripod, a table, or the like and so as to be movable to an appropriate position around the bed. In addition, by providing the detection unit 32D on the ceiling, it is easy to detect whether the positional relationship between the subject and the bed mattress is appropriate, from the upper surface of the bed. In addition, by providing a plurality of the detection unit 32D around the bed, such as left and right sides of the bed, it is easy to detect whether the positional relationship between the subject 16 and the medical bed mattress 10 is appropriate at a plurality of places on the left and right sides of the body axis and in the body axis direction. In addition, by installing the detection unit 32D on a mobile carriage, a portable tripod, a table, or the like to be movable, it is easy to detect whether the positional relationship between the subject and the bed mattress is appropriate while avoiding an influence caused by the size of the subject, obstacles, and the like.

The communication I/F unit 32E performs communication of a captured image (for example, a radiation image or a magnetic resonance image) and various types of information with an external device such as the console 34 by wireless communication or wired communication.

In addition, in the present embodiment, the controller 32A performs processing of detecting the marking 22 provided on the medical bed mattress 10 and notifying the detection result of the marking 22. For example, the controller 32A determines whether the detected state of the marking 22 is a predetermined state, and notifies of the determination result as the detection result of the marking 22. In a case where an optical imaging device such as a camera is applied as the detection unit 32D, the marking 22 and the subject 16 may be detected using the captured image, and it may be determined whether the marking 22 and the subject 16 are in a predetermined state by determining whether a positional relationship between the marking 22 and the subject 16 is within a predetermined range. Specifically, the controller 32A detects the positional relationship between the marking 22 and the subject 16 based on the detection result of the marking 22 by the detection unit 32D, and determines whether the medical bed mattress 10 is set to appropriately hold the subject 16. For example, the notification is provided by determining whether the state of the marking 22 detected by the detection unit 32D is a predetermined state and displaying the determination result on the display unit 32B.

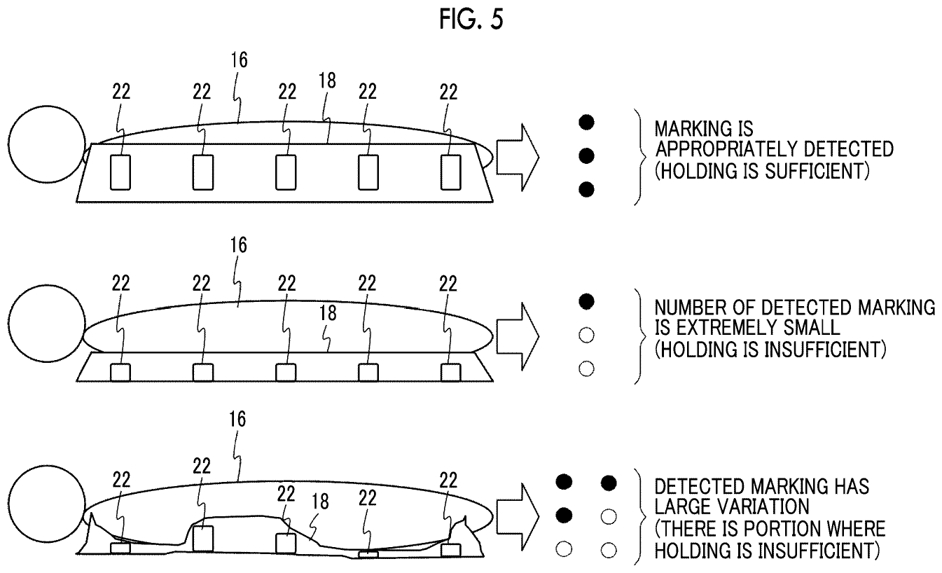

Here, an example of a determination method of whether the medical bed mattress 10 is set to appropriately hold the subject 16 in a case where the optical imaging device or the sensor is applied as the detection unit 32D will be described with reference to FIG. 5. FIG. 5 is a diagram for describing an example of a determination method as to whether the medical bed mattress 10 is set to appropriately hold the subject 16 in a case where the optical imaging device or the sensor is applied as the detection unit 32D. In the example of FIG. 5, an example is shown in which a plurality of (five) positions are arranged with three round marks as the marking 22.

The controller 32A detects the marking 22 at a plurality of positions by the detection unit 32D, and determines whether the state of the marking 22 is a predetermined state. For example, it is determined whether the medical bed mattress 10 is set to appropriately hold the subject 16 based on the number of times of detection of the round mark of each marking 22. Then, the notification is performed by displaying the determination result on the display unit 32B or the like.

Specifically, as shown in the upper part of FIG. 5, in a case where all the round marks of all the markings 22 at the plurality of positions are detected by the detection unit 32D, the controller 32A determines that the subject 16 is sufficiently held by the medical bed mattress 10. Then, a notification is performed by displaying a message such as “The medical bed mattress is appropriately set” on the display unit 32B or by outputting a voice.

In addition, as shown in the middle part of FIG. 5, in a case where one or two round marks of the marking 22 at all positions or a part of positions of the plurality of positions are detected, that is, in a case where three round marks are not detected at all positions, the controller 32A determines that the subject is insufficiently held by the medical bed mattress 10. Then, a notification is performed by displaying a message such as “Setting of medical bed mattress is insufficient” on the display unit 32B or by outputting a voice.

In addition, as shown in the lower part of FIG. 5, in a case where there is a large variation in the number of round marks of the marking 22 detected by the detection unit 32D at each position, the controller 32A determines that there is a portion in which the medical bed mattress 10 insufficiently holds the subject 16. Then, a notification is performed by displaying a message such as “Setting of medical bed mattress is insufficient” on the display unit 32B or by outputting a voice.

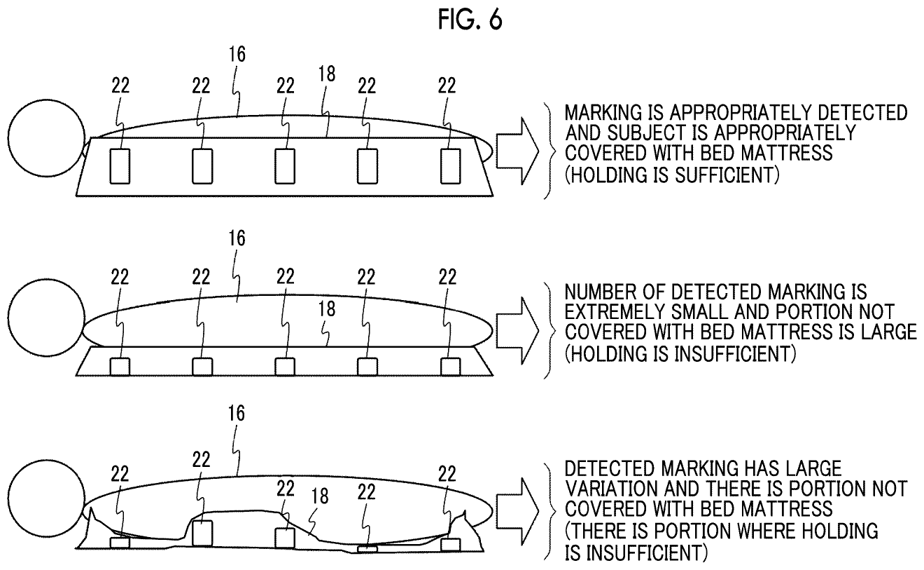

Next, an example of a determination method of determining whether the medical bed mattress 10 is set to appropriately hold the subject 16 in a case where the optical imaging unit is applied as the detection unit 32D will be described. FIG. 6 is a diagram for describing an example of a determination method as to whether the medical bed mattress 10 is set to appropriately hold the subject 16 in a case where the optical imaging unit is applied as the detection unit 32D. In the example of FIG. 6, an example is shown in which rectangular markings 22 in which the body axis direction of the subject 16 is the short side are disposed at a plurality of (five) positions.

The controller 32A detects the positional relationship between the subject 16 and the medical bed mattress 10 from the captured image captured by the optical imaging unit as the detection unit 32D, and determines whether the positional relationship is a predetermined positional relationship. In addition, the marking 22 is detected from the captured image, and it is determined whether the medical bed mattress 10 is set to appropriately hold the subject 16 based on the detection result of the marking 22. Then, the notification is performed by displaying the determination result on the display unit 32B or the like.

Specifically, the controller 32A extracts the subject 16 and the marking 22 from the captured image captured by the optical imaging unit as the detection unit 32D. Then, the position and the height of the subject 16 are read, and it is determined whether the positional relationship between the subject 16 and the marking 22 is in the positional relationship within a predetermined range, and the determination result is notified.

In addition, as shown in the upper part of FIG. 6, in a case where all the markings 22 at the plurality of positions are appropriately detected by the detection unit 32D, the controller 32A determines that the subject 16 is appropriately covered with the medical bed mattress 10 and the subject 16 is sufficiently held by the medical bed mattress 10. Then, a notification is performed by displaying a message such as “The medical bed mattress is appropriately set” on the display unit 32B or by outputting a voice.

In addition, as shown in the middle part of FIG. 6, in a case where the number of detected markings 22 is extremely small (for example, the length of the marking 22 in the longitudinal direction is equal to or less than a predetermined value), the controller 32A determines that the portion not covered with the medical bed mattress 10 is large and the subject is insufficiently held by the medical bed mattress 10. Then, the notification is performed by displaying a message such as “Setting of the medical bed mattress is overall insufficient from the shoulder to the leg” on the display unit 32B or by outputting a voice.

In addition, as shown in the lower part of FIG. 6, in a case where the detected marking 22 has a large variation (for example, the marking 22 has a large variation in the length in the longitudinal direction at each position), the controller 32A determines that there is a portion that is not covered with the medical bed mattress 10 and there is a portion where the holding of the subject 16 by the medical bed mattress 10 is insufficient. Then, the notification is performed by displaying a message such as “Setting of the medical bed mattress is insufficient in the upper arm and the leg” on the display unit 32B or by outputting a voice.

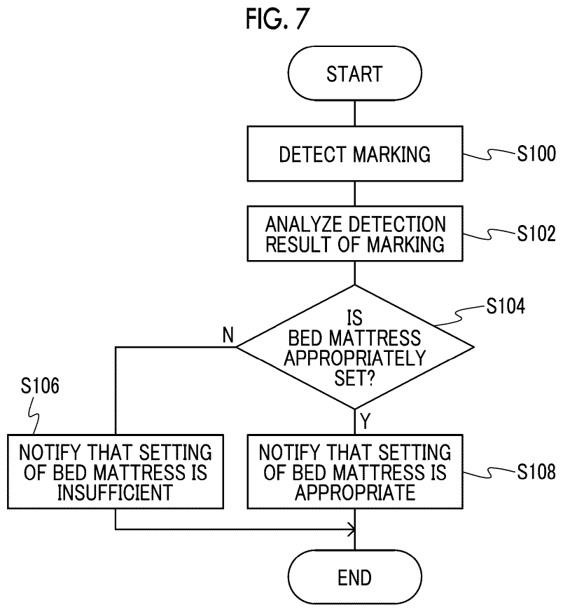

Subsequently, specific processing performed by the medical image examination system 30 according to the present embodiment configured as described above will be described. FIG. 7 is a flowchart showing an example of a flow of processing performed by the controller 32A of the medical image examination apparatus or the console 34 of the medical image examination system 30 according to the present embodiment. The processing in FIG. 7 is started, for example, in a case where the operator gives an instruction to start the processing, in a case where the operation of moving the bed 12 is performed, or in a case where it is detected from the captured image that the technician is absent. In addition, the processing will be described as processing performed by the controller 32A of the medical image examination apparatus 32. However the processing may be performed by the controller 34A of the console 34.

In step S100, the CPU 32F detects the marking 22 and the process proceeds to step S102. That is, the detection result of the detection unit 32D is acquired.

In step S102, the CPU 32F analyzes the detection result of the marking 22 and the process proceeds to step S104. For example, the state of the detected marking (for example, the number, size, and the like of the marking) is determined.

In step S104, the CPU 32F determines whether the setting of the medical bed mattress 10 is appropriate. The determination is made by the above-described determination method of determining whether the medical bed mattress 10 is set to appropriately hold the subject 16. In a case where the determination is negative, the process proceeds to step S106, and in a case where the determination is affirmative, the process proceeds to step S108.

In step S106, the CPU 32F notifies that the setting of the medical bed mattress 10 is insufficient and ends the series of processing. That is, the CPU 32F notifies that the holding state of the subject 16 by the holding part 18 is defective by displaying on the display unit 32B or the like. For example, at least one of sound, light, or display is used to notify that the setting is insufficient. The position of the marking 22 determined as defective from the detection result of the marking 22 of the detection unit 32D may be notified as a defective portion.

On the other hand, in step S108, the CPU 32F notifies that the setting of the medical bed mattress 10 is appropriate, and ends the series of processing. That is, the CPU 32F notifies that the holding state of the subject 16 by the holding part 18 is favorable by displaying on the display unit 32B or the like. For example, at least one of sound, light, or display is used to notify that the setting is appropriate.

As described above, in the medical bed mattress 10 according to the present embodiment, since the marking 22 is provided on the holding part 18, it is possible to check whether the subject 16 can be appropriately fixed.

In addition, in the medical image examination system 30 according to the present embodiment, it is possible to check whether the subject 16 is appropriately set on the medical bed mattress 10 before capturing the medical image.

In the above-described embodiment, the processing of FIG. 7 is described as being performed by the controller 32A or the controller 34A. However the processing may be performed by the controller 32A and the controller 34A in cooperation with each other, or may be performed in cooperation with another device.

In addition, various types of processing executed by the CPU by executing software (program) in the above-described embodiment may be executed by a computer equipped with various processors other than the CPU. In this case, the examples of the processors include a programmable logic device (PLD) such as a field-programmable gate array (FPGA) having a circuit configuration changeable after manufacturing, a dedicated electric circuit such as an application specific integrated circuit (ASIC) that is a processor having a circuit configuration dedicatedly designed to execute specific processing, and the like. The various types of processing may be executed by one of the various processors or may be executed by a combination of two or more processors of the same kind or different kinds (for example, a plurality of FPGAs and a combination of a CPU and an FPGA). The hardware structure of various processors is more specifically an electric circuit in which circuit elements, such as semiconductor elements, are combined.

Further, in the above embodiment, an aspect in which various programs are stored (installed) in the ROM 32G in advance has been described. However the present disclosure is not limited thereto. The various programs may be provided in a form of being recorded in a recording medium such as a compact disk read only memory (CD-ROM), a digital versatile disk read only memory (DVD-ROM), a universal serial bus (USB) memory, and the like. In addition, the various programs may be downloaded from an external information processing apparatus or the like via a network.

In addition, the configuration, operation, and the like of the medical image examination system 30 described in the above-described embodiment are merely examples, and it goes without saying that the configuration, operation, and the like can be changed according to the situation without departing from the spirit of the present disclosure.

The following Supplementary Notes are further disclosed with respect to the above embodiment.

### Supplementary Note 1

A medical bed mattress comprising:
a pair of holding parts that are disposed to be in contact with both side surfaces of a subject; and
a mark that is provided on at least one holding part of the pair of holding parts and that is used to check a positional relationship between the holding part and the subject.

### Supplementary Note 2

The medical bed mattress according to supplementary note 1,
wherein the holding part has a translucent or transparent portion in at least a part of the holding part.

### Supplementary Note 3

A medical image examination apparatus comprising:

a processor,
wherein the processor is configured to perform processing of:
   detecting the mark provided on the medical bed mattress according to supplementary note 1 or 2; and
   notifying of a detection result of the mark.

### Supplementary Note 4

The medical image examination apparatus according to supplementary note 3,
wherein the processor is configured to determine whether a detected state of the mark is a predetermined state and notify of a determination result as the detection result of the mark.

### Supplementary Note 5

The medical image examination apparatus according to supplementary note 4,
wherein the processor is configured to:
   detect the mark and the subject using a captured image captured by an imaging unit that images the mark and the subject; and
   determine whether the detected state of the mark is the predetermined state by determining whether a positional relationship between the mark and the subject is within a predetermined range.

### Supplementary Note 6

The medical image examination apparatus according to supplementary note 4 or 5,
wherein the processor is configured to notify that a holding state of the holding part is defective in a case where the holding part is not in a predetermined state.

### Supplementary Note 7

The medical image examination apparatus according to any one of supplementary notes 4 to 6,
wherein the processor is configured to notify that a holding state of the holding part is favorable in a case where the holding part is in a predetermined state.

### Supplementary Note 8

The medical image examination apparatus according to supplementary note 6,
wherein a plurality of the marks are provided on the medical bed mattress, and
the processor is configured to notify of a location at which the holding state of the holding part is defective.

### Supplementary Note 9

The medical image examination apparatus according to supplementary note 8,
wherein the processor is configured to:
   detect the plurality of marks; and
   notify of a position of the mark detected as defective, as the location at which the holding state of the holding part is defective.

### Supplementary Note 10

A medical image examination method comprising:
via a computer,
performing processing of:
   detecting the mark provided on the medical bed mattress according to supplementary note 1 or 2; and
   notifying of a detection result of the mark.

### Supplementary Note 11

A medical image examination program for causing a computer to execute processing of:
detecting the mark provided on the medical bed mattress according to supplementary note 1 or 2; and
notifying of a detection result of the mark.

What is claimed is:

1. A medical bed mattress comprising:
a pair of holders that are disposed to be in contact with both side surfaces of a subject; and
a mark that is provided on at least one holder of the pair of holders and that is used to check a positional relationship between the holder and the subject.

2. The medical bed mattress according to claim 1,
wherein the holder has a translucent or transparent portion in at least a part of the holder.

3. A medical image examination apparatus comprising:
a processor,
wherein the processor is configured to perform processing of:
detecting the mark provided on the medical bed mattress according to claim 1; and
notifying of a detection result of the mark.

4. The medical image examination apparatus according to claim 3,
wherein the processor is configured to:
determine whether a detected state of the mark is a predetermined state; and
notify of a determination result as the detection result of the mark.

5. The medical image examination apparatus according to claim 4,
wherein the processor is configured to:
detect the mark and the subject using a captured image captured by a camera that images the mark and the subject; and
determine whether the detected state of the mark is the predetermined state by determining whether a positional relationship between the mark and the subject is within a predetermined range.

6. The medical image examination apparatus according to claim 4,
wherein the processor is configured to notify that a holding state of the holder is defective in a case where the holder is not in a predetermined state.

7. The medical image examination apparatus according to claim 4,
wherein the processor is configured to notify that a holding state of the holder is favorable in a case where the holder is in a predetermined state.

8. The medical image examination apparatus according to claim 6,
wherein a plurality of the marks are provided on the medical bed mattress, and
the processor is configured to notify of a location at which the holding state of the holder is defective.

9. The medical image examination apparatus according to claim 8,
wherein the processor is configured to:
detect the plurality of marks; and
notify of a position of the mark detected as defective, as the location at which the holding state of the holder is defective.

10. A medical image examination method comprising:
via a computer,
performing processing of:
detecting the mark provided on the medical bed mattress according to claim 1; and
notifying of a detection result of the mark.

11. A non-transitory computer-readable storage medium storing a medical image examination program executable by a computer to execute processing of:
detecting the mark provided on the medical bed mattress according to claim 1; and
notifying of a detection result of the mark.
